(19) United States
(12) Patent Application Publication
(10) Pub. No.: US 2013/0224707 A1
(43) Pub. Date: Aug. 29, 2013

(54) Mixed Martial Arts Kick Training Device

(71) Applicant: Ray Newkirk, Kirkville, NY (US)

(72) Inventor: Ray Newkirk, Kirkville, NY (US)

(21) Appl. No.: 13/779,997

(22) Filed: Feb. 28, 2013

Related U.S. Application Data
(60) Provisional application No. 61/604,040, filed on Feb. 28, 2012.

(51) Int. Cl. G09B 19/00

(52) U.S. Cl. CPC G09B 19/00
USPC 434/247

(57) ABSTRACT

An embodiment of the present invention contemplates a martial arts kick training device that generally includes a belt, an elongated target that extends downwardly from the belt, and a foot plate. The elongated target comprises a pad, preferably thick and wide enough to fully absorb the force of a trainee's kicks, and a metal plate to which the pad is attached. The foot plate extends integrally from the metal plate and is adapted to be stepped upon by the sparring partner while training.

### REFERENCE TO RELATED APPLICATION

The present application relates to and claims priority to applicant's U.S. Provisional Patent Application Ser. No. 61/604,040, filed Feb. 28, 2012, the entirety of which is hereby incorporated by reference.

### BACKGROUND

1. Field of Invention

The present invention relates to mixed martial arts training devices, and more particularly to a safety device used to train kicking.

2. Background of Art

Mixed martial arts is a full contact combat sport that allows the use of both striking and grappling techniques, both standing and on the ground, including boxing, wrestling, Brazilian jiu-jitsu, muay Thai, kickboxing, taekwondo, karate, judo and other styles. One common form of striking is done by kicking an opponent either above or below the waist.

Sparring is one form of training and involves a trainer or sparring partner that absorbs the strikes delivered by the trainee. A sparring partner will typically hold pads or other protective devices to permit the trainee to fully engage but without hurting the sparring partner.

Notwithstanding the use of pads that are held by the sparring partner, when the trainee practices kicks below the waist, there is generally no protection for the sparring partner who must absorb the kicks in his or her own legs. Leg injuries, therefore, are a significant and frequent occurrence amongst sparring partners.

3. Objects and Advantages

It is therefore a principal object and advantage of the present invention to provide a safety device to be used by a sparring partner to protect against kicks to the leg region.

It is another object and advantage of the present invention to provide a safety training aid that minimally impedes a trainer's movement.

Other objects and advantages of the present invention will in part be obvious and in part appear hereinafter.

### SUMMARY OF THE INVENTION

In accordance with the foregoing objects and advantages, the present invention provides a training aid used by a trainer or sparring partner to absorb the impact of kicks to the leg. In an embodiment of the present invention, the training device generally comprises a belt, an elongated target that extends downwardly from the belt, and a foot plate. The elongated target comprises a pad, preferably thick and wide enough to fully absorb the force of a trainee's kicks, and a metal plate to which the pad is attached. The foot plate extends integrally from the metal plate and is adapted to be stepped upon by the sparring partner while training. When a trainee kicks the target, the force of the kick is both absorbed by the pad with the vibrations caused by the force transmitted via the metal plate to the foot plate, thereby removing or minimizing the impact of most, if not all, of the kick's force from the sparring partner's own leg.

### BRIEF DESCRIPTION OF THE DRAWINGS

The present invention will be more fully understood and appreciated by reading the following Detailed Description in conjunction with the accompanying drawings, in which:

FIG. 1 is a perspective view of a sparring partner using an embodiment of the training aid of the present invention.

FIG. 2 is a side elevation view of an embodiment of the present invention.

FIG. 3 is a schematic representation of the lower portion of an embodiment of the present invention.

FIG. 4 is a front elevation view of an embodiment of the present invention.

### DETAILED DESCRIPTION

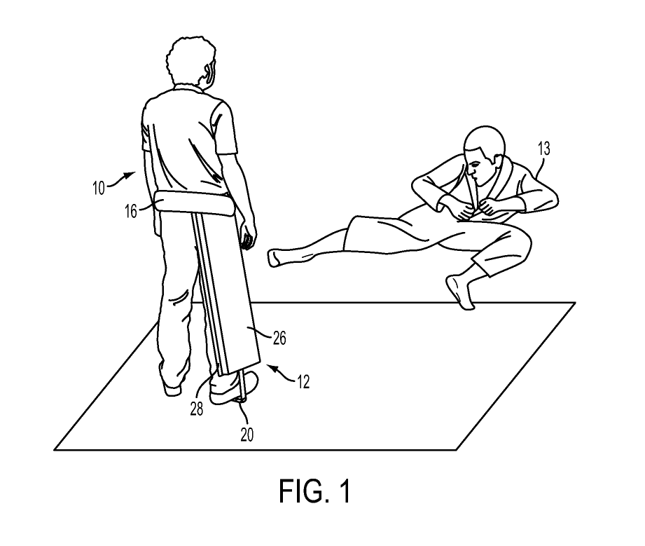

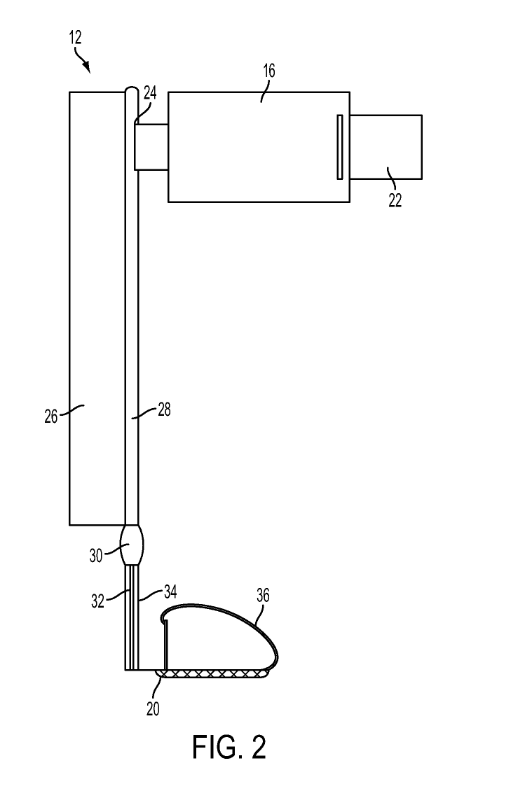

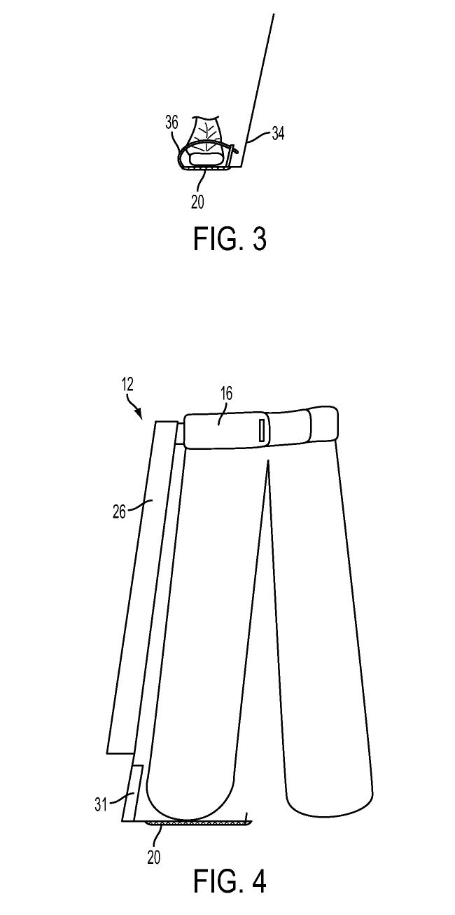

Referring now to the drawings in which like reference numeral refer to like parts throughout, there is seen in FIG. 1 a sparring partner/trainer 10 utilizing an embodiment of a safety kick training device, designated generally by referee numeral 12, adapted to absorb the force of a kick to the sparring partner's leg imparted by a trainee 13. Training device 12 generally comprises a belt 16, a target 18 that extends downwardly from the belt 14, and a foot plate 20 that extends downwardly from the target 18.

Belt 16 comprises an adjustable strap of material with hook and loop or other conventional fastening mechanisms 22 provided for securely attaching around a trainer's waist. In use, belt 16 passes through a loop 24 provided on target 18 to interconnect the belt and target and then is fastened around the trainer's waist. Utilization of the belt 16 also permits the trainer's hands to be free to hold other padding to protect against punches and high kicks, or otherwise use his/her arms to deflect or block strikes.

Target 18, in addition to including belt loop 24, further comprises an elongated pad 26 and an elongated strip of metal 28 to which the pad is adhered or otherwise connected. Pad 26 is preferably of a width and thickness to adequately cover the outside of the trainer's leg and absorb the force of the trainee's kicks. Metal strip 28 is joined by a swivel joint 30 to a lower metal strip 32 that connects to foot plate 20. Lower metal strip 32 telescopically rides within a tubular member 34 to permit effective use of the device by trainers of differing heights and use of device 12 at differing angles.

Foot plate 20 extends downwardly from target 18 and bends at essentially a right angle such that the trainer's foot can be placed on top thereof, such that foot plate 20 is sandwiched between the bottom of the trainer's foot and the floor. In addition, foot plate 20 includes a foot strap 36 that is placed over the top of the trainer's foot to retain the foot plate to the trainer's foot as he/she moves. By standing on top of foot plate 20, the training device 12 is stabilized when in use. In addition, the integral nature of the foot plate 20 with metal strip 28 provides a transmission pathway for the force imparted to the target 18 by the trainee's kick, thereby substantially reducing and perhaps eliminating the impact of the kicking force that would otherwise be received by the trainer's leg.

What is claimed is:

1) A martial arts kick training device, comprising:
a) a belt;
b) an elongated target that extends downwardly from said belt; and
c) a foot plate connected to said target.

2) The martial arts kick training device of claim 1, further comprising:
a) a swivel joint that interconnects said foot plate to said target.

3) The martial arts kick training device of claim 1, wherein said target further comprises:
a) an elongated pad; and
b) an elongated trip of metal material attached to said pad.

4) The martial arts kick training device of claim 3, further comprising:
a) a swivel joint interconnecting said foot plate to said target, and
b) a telescopic rod to which said footplate is attached and that is attached to said swivel plate.

5) A method for a sparring partner to train a martial artist, comprising the steps of:
a) providing a kick training device comprising a belt; an elongated target that extends downwardly from said belt; and a foot plate connected to said target;
b) fastening said belt around the waist of the sparring partner such that said target extends along the leg of the sparring partner; and
c) inserting the sparring partner's foot within said foot plate.
